(19) United States
(12) Patent Application Publication
(10) Pub. No.: US 2011/0278276 A1
(43) Pub. Date: Nov. 17, 2011

(54) PROCESS AND APPARATUS FOR CONTINUOUS PURIFICATION OF A SOLID MIXTURE BY FRACTIONAL SUBLIMATION/DESUBLIMATION

(75) Inventors: Markus Linsenbuehler, Ludwigshafen (DE); Bernd Sachweh, Meckenheim (DE); Joerg Halpap, Mannheim (DE); Martin Karches, Neustadt (DE); Reinhold Rieger, Offstein (DE)

(73) Assignee: BASF SE, Ludwigshafen (DE)

(21) Appl. No.: 13/146,487

(22) PCT Filed: Jan. 25, 2010
(86) PCT No.: PCT/EP2010/050755

§ 371 Date: Jul. 27, 2011

(30) Foreign Application Priority Data
Jan. 27, 2009 (EP) 09151409.1

(51) Int. Cl. H05B 1/00; B01D 7/00

(52) U.S. Cl. 219/201; 201/4

(57) ABSTRACT

A process is proposed for continuously purifying a solid mixture comprising a sublimable product of value and components with lower and higher sublimation temperatures by fractional sublimation/desublimation in a hot wall tubular oven (1) with supply of the solid mixture together with an inert gas stream, into which the solid mixture is dispersed by means of a dispersing unit (2), at one end of the hot wall tubular oven (1),
heating the dispersed solid mixture in the hot wall tubular oven (1) at a temperature at which the product of value sublimes to obtain a gas mixture comprising components with a higher sublimation temperature than the product of value as solid particles,
passing the gas mixture comprising components with a higher sublimation temperature than the product of value as solid particles through a hot gas filter (3) with a suitable pore size in order to retain the solid particles with a higher sublimation temperature than the product of value,
cooling the gas mixture from which the components with a higher sublimation temperature than the product of value have been removed to a temperature at which the product of value desublimes, and at which the components with a lower sublimation temperature than the product of value are yet to desublime, to obtain a gas mixture comprising the particulate product of value and
separating the purified particulate product of value from the cooled gas mixture.

The invention relates to a process and to an apparatus for continuously purifying a solid mixture comprising a product of value by sublimation/desublimation, especially for obtaining the product of value in the form of nanoparticles.

One field in which nanoparticles are produced and used relates to pigments as used for coloring, for example in coatings. With decreasing size of the particles, in the case of pigments for example, the brightness and the color strength of the coatings are improved.

A further field in which nanoparticles are used relates to catalysts. For instance, with decreasing mean particle diameter, the total surface area of the catalyst based on the mass is increased, which results in a more effective action of the catalyst.

In addition, the use of nanoparticles in the sector of pharmaceutical products or crop protection compositions can increase the bioavailability thereof.

In the case of materials which are applied to a substrate by vapor deposition in a production process, it is advantageous when the particles are present in very finely divided form, in order that they can be converted to the gas phase more rapidly and the thermal stress can thus be reduced.

Nanoparticulate solids can be produced by various processes. These pulverulent solids are commonly obtained by grinding steps, reactions in the gas phase or in a flame, by crystallization, precipitation or sol-gel processes, in a plasma or by desublimation.

In a known manner, nanoparticles are understood to mean solids or liquid droplets with a particle diameter of <1 μm or else <10 μm. Owing to their dimensions, nanoparticles have properties of which some differ fundamentally from properties of the same substance in each case which, however, are present in less finely distributed form.

More particularly, particulate products of value should be provided in a purity which is sufficient for electronics applications, i.e. in electronics grade purity. This is generally understood to mean that an upper limit for impurities in the single-digit ppm range, or else in the ppb range, must not be exceeded.

There is a known process for batchwise purification of solids by sublimation/desublimation in a gradient oven from Creaphys to obtain ultra-high purity substances suitable for electronics applications, especially in solar cells.

However, the process is not usable for purification of solids on a large scale.

It was an object of the invention to provide a process which is technically simple to implement for continuously purifying a solid mixture, which is also usable on the industrial scale, and ensures a high product quality, especially a very homogeneous particle size distribution with homogeneous morphology in high purity, with simultaneously high space-time yield.

More particularly, it was an object of the invention to provide a process as defined above for obtaining the product of value in the form of nanoparticles.

This object is achieved by a process for continuously purifying a solid mixture comprising a sublimable product of value and components with lower and higher sublimation temperatures by fractional sublimation/desublimation in a hot wall tubular oven (1) with supply of the solid mixture together with an inert gas stream, into which the solid mixture is dispersed by means of a dispersing unit (2), at one end of the hot wall tubular oven (1),
heating the dispersed solid mixture in the hot wall tubular oven (1) at a temperature at which the product of value sublimes to obtain a gas mixture comprising components with a higher sublimation temperature than the product of value as solid particles,
passing the gas mixture comprising components with a higher sublimation temperature than the product of value as solid particles through a hot gas filter (3) with a suitable pore size in order to retain the solid particles with a higher sublimation temperature than the product of value,
cooling the gas mixture from which the components with a higher sublimation temperature than the product of value have been removed to a temperature at which the product of value desublimes, and at which the components with a lower sublimation temperature than the product of value are yet to desublime, to obtain a gas mixture comprising the particulate product of value and
separating the purified particulate product of value from the cooled gas mixture.

It has been found that it is possible to provide particulate products of value in high purity even on the industrial scale by continuously performing a fractional sublimation/desublimation in a single apparatus.

By virtue of, in accordance with the invention, in a section of the hot wall tubular oven in which is arranged a suitable deposition apparatus, i.e. a hot gas filter with a suitable pore size, in which components with a higher sublimation temperature than the product of value are removed from the solid mixture to be purified, it is possible to ensure conditions under which homogeneous nucleation occurs, which leads to a loose product with homogeneous morphology and very homogeneous particle size distribution.

The process proceeds from a solid mixture which comprises sublimable product of value, and additionally components with lower and higher sublimation temperatures. In addition, the solid mixture may also comprise further, nonsublimable components.

The solid mixture to be purified is supplied to a hot wall tubular oven, at one end thereof. It is advantageous to distribute the solid mixture supplied homogeneously, by supplying it through a dispersing unit, preferably through a dosage channel, a star feeder, a brush feeder or a spiral jet mill.

The hot wall tubular oven is advantageously arranged vertically and has a hot wall which is preferably heated electrically, especially by means of heating wires. The hot wall tubular oven may have a single heating zone. Preference is given to a multizone hot wall tubular oven, i.e. a hot wall tubular oven with two, three or more heating zones. The two, three or more heating zones can be achieved with two or more heating regulators, but also by a different closeness of winding of heating wires.

The sublimable product of value is especially an organic solid, preferably an organic solid in electronics grade purity, more preferably an organic pigment.

The solid mixture is supplied to the hot wall tubular furnace together with an inert gas stream, i.e. a gas stream with which the components of the solid mixture do not react chemically.

To prevent brief significant thermal stress on the solid mixture to be purified as a result of contact with the walls of the hot wall tubular oven, in a preferred process variant, the inert gas stream comprising the solid mixture is surrounded in a filling gas stream. Suitable filling gases are, just like the inert gas, gases which are inert toward the solid mixture to be purified. The filling gas is supplied to the hot wall tubular oven preferably over the circumference thereof, via gas feed nozzles. The gas feed nozzles may preferably be aligned such that the filling gas is supplied to the hot wall tubular oven in parallel to the walls thereof, preventing the filling gas from already mixing completely with the inert gas comprising the solid mixture to be purified at the inlet.

In a further preferred embodiment, the walls of the hot wall tubular oven are formed from a porous sintered material, through which homogeneous supply of the filling gas into the hot wall tubular oven can be achieved.

In order to achieve homogeneous sublimation and homogeneous thermal stress, especially of thermally labile substances, the temperature in the hot wall tubular oven is preferably regulated such that the lowest temperature is at most 20% lower than the highest temperature which occurs in the hot wall tubular oven.

The hot wall tubular oven may, especially in order to ensure thermally gentle treatment of thermally labile substances, be operated under reduced pressure. In the case of sufficiently short residence times, the hot wall tubular oven may, however, advantageously also be operated at a pressure of about 1 bar absolute, in which case the residence times, depending on the thermal sensitivity of the solid mixture to be purified, are in the range from 0.1 to 1 h, preferably from 0.1 to 100 s, more preferably in the range from 0.5 to 5 s.

By the process according to the invention, it is possible to purify especially monomers, oligomers or polymers. Accordingly, the solid mixture to be purified may also have a sublimation point or else a sublimation range.

The dispersed solid mixture to be purified is first heated up to close to the sublimation range or close to the sublimation point of the product of value, preferably to about 5° C. above or below the sublimation range or above or below the sublimation point of the product of value.

The inert gas stream which now comprises the product of value and components with a lower sublimation temperature in vaporous form, components with a higher sublimation temperature than the product of value and nonsublimable components, but still in solid form, is passed through a hot gas filter which is selected with a suitable pore size in order to retain the solid particles with a higher sublimation temperature than the product of value and, if any, the nonsublimable solid particles. The hot gas filter is likewise heated to a temperature which is close to the sublimation range or the sublimation point of the product of value, preferably about 5° C. above or below the sublimation range or above or below the sublimation point of the product of value.

The material for the hot gas filter must therefore be selected appropriately, such that it is thermally stable, according to the sublimation range or sublimation point of the product of value to be purified. Useful materials for the hot gas filter include especially metal, ceramic, glass fibers or else plastic, especially polytetrafluoroethylene.

The function of the hot gas filter can also be assumed by another separator by solid particles known to those skilled in the art, especially hot gas electrofilters, or else cyclones.

Advantageously, appropriate regulation of the heating ensures that any temperature decline in the region of the hot gas filter is prevented.

Further along the hot wall tubular oven, downstream of the hot gas filter, a central cone with its tip pointed upward may advantageously be arranged in order to pass the laden inert gas to the wall of the hot wall tubular oven.

Downstream of the hot gas filter and if appropriate the cone for flow control is arranged, in the hot wall tubular oven, a quench region in which the gas mixture from which the components with a higher sublimation temperature than the product of value have been separated in the hot gas filter is cooled to a temperature at which the product of value desublimes and at which the components with a lower sublimation temperature than the product of value are yet to desublime to obtain a gas mixture comprising the purified particulate product of value. This is separated from the cooled gas mixture in a next process step.

The cooling is preferably effected very rapidly, i.e. with a residence time of <0.1 s to <100 s, especially by means of a gas quench or a Laval nozzle.

The cooling is preferably effected in a gas quench, especially to ambient temperature, the mass ratio between the inert gas laden with the components of the solid mixture and the quench gas advantageously being set within the range between 1:5 and 1:10.

According to requirements, the cooling may, however, also be performed over a longer period, in a delay vessel. This is advantageous especially in the case of high proportions of readily sublimable substances.

The separation of the purified particulate product of value from the gas stream is preferably effected in an electrofilter.

The purified particulate product of value may still be contaminated by low boilers. It is therefore preferable to further purify the purified particulate product of value to free it of low boilers by fractional sublimation/desublimation, i.e. to “degas” the product of value.

In an advantageous variant, the cooling of the gas mixture comprising components with a higher sublimation temperature than the product of value as solid particles to a temperature at which the product of value desublimes can be effected in the presence of inert carrier particles. The inert carrier particles may preferably be spherical and more preferably have a diameter in the single-digit millimeter range. Desublimation of the product of value onto inert carrier particles especially improves the handling.

The cooling of the gas mixture comprising components with a higher sublimation temperature than the product of value in the presence of inert carrier particles is preferably effected at a temperature and a pressure which are controlled so as to deposit, on the inert carrier particles, a solid layer of the product of value with a thickness in the range from 1 to 200 μm.

The invention also provides a hot wall tubular oven for continuously purifying a solid mixture comprising a product of value and components with lower and higher sublimation temperatures by fractional sublimation/desublimation
with a supply nozzle for the supply of the solid mixture together with an inert gas stream into which the solid mixture is dispersed by means of a dispersing unit, at one end of the hot wall tubular oven,
1, 2, 3 or more heating zones for heating the dispersed solid mixture in the hot wall tubular oven at a temperature at which the product of value sublimes to obtain a gas mixture comprising components with a higher sublimation temperature than the product of value as particles,
a hot gas filter with a suitable pore size for passage of the gas mixture comprising components with a higher sublimation temperature than the product of value as particles in order to retain the particles with a higher sublimation temperature than the substance of value, and comprising
a gas quench, a Laval nozzle or a delay vessel for cooling the gas mixture comprising components with a higher sublimation temperature than the product of value as solid particles to a temperature at which the product of value desublimes to obtain the purified particulate product of value.

The dispersing unit is preferably a spiral jet mill, a dosage channel, a star feeder or a brush feeder.

The hot wall tubular oven is preferably electrically heated on its outer jacket. An electrical heater can be regulated simply and accurately.

The hot gas filter is preferably formed from metal, ceramic, glass fibers or plastic.

The invention is illustrated in detail hereinafter with reference to a drawing.

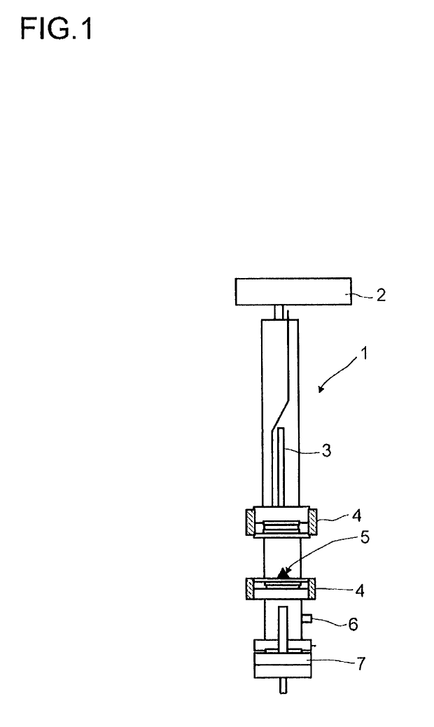

The sole FIGURE, FIG. 1, shows a vertical hot wall tubular oven 1 with a dispersing unit 2 for the supply of the solid mixture to be separated together with an inert gas stream.

The solid mixture dispersed in the inert gas stream is passed through a hot gas filter 3 which is mounted by means of a flange 4 with heating collars, then passed through a cone 5 for control of the gas flow and cooled in a gas quench with supply nozzles 6 for the quench gas. The purified particulate product of value is removed from the inert gas stream in the separator 7.

### WORKING EXAMPLE

200 g of impurity containing copper phthalocyanine (abbreviated in the following as CuPc) have been dosed continuously with a brush feeder RBG® 2000 of the firm Palas, in six hours with 1 m³/hour of azote into a hot wall oven (interior diameter: 40 mm, length: 1,200 mm) vertically passed through.

The interior pressure of the plant was 1.1 bar absolute.

By using an oven of the firm HTM Reetz with six zones, a constant temperature of 500° C. was adjusted over the entire oven length of the hot wall reactor. The sublimate stream containing impurities was purified by means of 4 parallel candles of a sintered metal with a length of 300 mm and an external diameter of 10 mm, which were arranged 150 mm before the gas outlet from the hot wall reactor.

By introducing 1 m³/h azote after the hot wall reactor, the temperature of the gas stream was reduced below the desublimation temperature, and subsequently the desublimated product of value was separated from the gas stream in an electric filter.

Colour tests with the purified material showed a 10% higher colour intensity in comparison with the same starting material being finished via a classic milling process.

Furthermore, it could be demonstrated that a solar cell which has been coated with a copper phthalocyanine obtained according to the above working example showed the same electric tension like a solar cell which was deposited with copper phthalocyanine obtained starting from the same starting material, but which was purified according to the discontinuous purifying process of the state of the art, in a gradient oven, under a vacuum 10⁻⁴ mbar over a high residence time of 4 hours.

Moreover, the purifying process according to the invention has, when compared with purifying in a gradient oven according to the state of the art, the further essential advantage that it is continuous, and accordingly compatible to scale-up, while purifying in a gradient oven is discontinuous.

1-22. (canceled)

23. A process for continuously purifying a solid mixture comprising a sublimable product of value and components with lower and higher sublimation temperatures, the process comprising:
heating a dispersed solid mixture in a hot wall tubular oven at a temperature at which the product of value sublimes to obtain a gas mixture comprising components with a higher sublimation temperature than the product of value as solid particles;
passing the gas mixture comprising components with a higher sublimation temperature than the product of value as solid particles through a hot gas filter, which is arranged in a section of the hot wall tubular oven, with a suitable pore size in order to retain the solid particles with a higher sublimation temperature than the product of value, to obtain a filtered gas mixture;
cooling the filtered gas mixture from which the components with a higher sublimation temperature than the product of value have been removed to a temperature at which the product of value desublimes, and at which the components with a lower sublimation temperature than the product of value are yet to desublime, to obtain a cooled gas mixture comprising the particulate product of value; and
separating purified particulate product of value from the cooled gas mixture,
wherein, to obtain the dispersed solid mixture, a solid mixture is dispersed into the hot wall tubular oven by a dispensing unit at one end of the hot wall tubular oven, together with an inert gas.

24. The process of claim 23, wherein the purified particulate product of value is obtained with a mean particle size of <10 μm.

25. The process of claim 23, wherein the hot wall tubular oven is a multipurpose hot wall tubular oven.

26. The process of claim 23, wherein the product of value is sublimable and is an organic solid.

27. The process of claim 26, wherein the organic solid is obtained in electronics grade purity.

28. The process of claim 27, wherein the organic solid in electronics grade purity is a pigment.

29. The process of claim 23, wherein a pressure at an exit from the hot wall tubular oven is about 1 bar absolute, and
wherein a residence time of the solid mixture to be purified in the hot wall tubular oven is in a range from 0.1 to 1 hour.

30. The process of claim 23, wherein the dispersing unit is a dosage channel, a star feeder, a brush feeder, or a spiral jet mill.

31. The process of claim 23, wherein the hot wall tubular oven is electrically heated on its outer jacket.

32. The process of claim 25, wherein the hot wall tubular oven is electrically heated on its outer jacket and has at least (two) heating zones.

33. The process of claim 23, wherein the dispersed solid mixture is heated up to close to a sublimation range or close to a sublimation point of the product of value.

34. The process of claim 23, wherein the hot gas filter is formed from metal, ceramic, at least one glass fiber, or from plastic.

35. The process of claim 23, wherein the gas mixture comprising components with a higher sublimation temperature than the product of value as solid particles is cooled for a residence time of <0.1 s to <100 s.

36. The process of claim 23, wherein the gas mixture comprising components with a higher sublimation temperature than the product of value as solid particles is cooled by a gas quench or a Laval nozzle.

37. The process of claim 23, wherein the purified particulate product of value is deposited in an electrofilter.

38. The process of claim 23, further comprising:
removing low boilers by fractional sublimation/desublimation from the purified particulate product of value.

39. The process of claim 23, wherein the gas mixture comprising components with a higher sublimation temperature than the product of value as solid particles are cooled to a temperature at which the product of value desublimes in the presence of at least one inert carrier particle.

40. The process of claim 39, wherein the cooling is effected at a temperature and a pressure which are controlled so as to deposit, on the at least one inert carrier particle, a solid layer of the product of value with a thickness in a range from 1 to 200 μm.

41. A hot wall tubular oven, comprising
supply nozzle which supplies of the solid mixture together with an inert gas stream into which the solid mixture is dispersed by a dispersing unit, at one end of the hot wall tubular oven;
at least one heating zone which heats a dispersed solid mixture in the hot wall tubular oven at a temperature at which a product of value sublimes to obtain a gas mixture comprising components with a higher sublimation temperature than the product of value as particles,
a hot gas filter, which is arranged in a section of the tubular hot wall oven, with a suitable pore size for passage of the gas mixture comprising components with a higher sublimation temperature than the product of value as particles in order to retain particles with a higher sublimation temperature than the substance of value, and
a gas quench, a Laval nozzle, or a delay vessel which cools the gas mixture comprising components with a higher sublimation temperature than the product of value as particles to a temperature at which the product of value desublimes to obtain a purified particulate product of value,
wherein the hot wall tubular oven is suitable for continuously purifying a solid mixture comprising a product of value and components with lower and higher sublimation temperatures by fractional desublimation/sublimation.

42. The oven of claim 41, wherein the dispersing unit is a dosage channel, a star feeder, a brush feeder, or a spiral jet mill.

43. The oven of claim 41, which is electrically heated on its outer jacket.

44. The oven of claim 41, wherein the hot gas filter is formed from metal, ceramic, at least one glass fiber, or plastic.

45. The process of claim 29, wherein the residence time of the solid mixture to be purified in the hot wall tubular oven is in a range from 0.1 to 100 seconds.

46. The process of claim 45, wherein the residence time of the solid mixture to be purified in the hot wall tubular oven is in a range from 0.5 to 5 seconds.

47. The process of claim 39, wherein the inert carrier particles are spherical.

48. The process of claim 47, wherein the inert carrier particles have a diameter in a single-digit millimeter range.
